(19) United States
(12) Patent Application Publication
(10) Pub. No.: US 2016/0243887 A1
(43) Pub. Date: Aug. 25, 2016

(54) TAXIDERMIST'S FIXTURE AND METHOD OF USING THE SAME

(71) Applicant: Samuel Brewer, Greensboro, NC (US)

(72) Inventor: Samuel Brewer, Greensboro, NC (US)

(21) Appl. No.: 15/044,343

(22) Filed: Feb. 16, 2016

Related U.S. Application Data
(60) Provisional application No. 62/118,509, filed on Feb. 20, 2015.

(51) Int. Cl. B44C 5/06; G09B 23/36

(52) U.S. Cl. CPC B44C 5/06; G09B 23/36

(57) ABSTRACT

An adjustable fixture for taxidermists. The fixture includes a base having a length defining a length direction and a height defining a height direction. The fixture also includes at least two supports adjustably attached to the base for selective adjustment along the length of the base. The supports are also adjustably attached to the base for selective adjustment in the height direction. The supports accept and securely hold rods extending from the feet of an animal pre-form.

### FIELD OF INVENTION

The present disclosure relates to the field of taxidermy. Particularly, the present disclosure relates to a fixture or jig for use by taxidermists when preparing an animal for display.

### BACKGROUND

The practice of taxidermy provides a process for hunters and fisherman to display their catch. Taxidermy is also used to prepare display animals for visual enjoyment in museums. Traditionally, the skin is removed from the deceased animal. The skin is then tanned to preserve the skin or fur of the animal. The taxidermist then employs their skill and artistry to assemble the skin on a foam pre-form or manikin, and applies additional synthetic elements, such as eyes, to recreate a life-like representation of the original animal.

### SUMMARY

The present disclosure is directed to a fixture for use by taxidermists during preparation of an animal. The fixture includes a base, such as a plate, bar, or sheet formed of metal, wood, composite, polymer, or other material. The base extends along a length direction and in a height direction. The fixture includes at least two supports adjustably attached to the base for selective adjustment along the length of the base. The supports are also adjustably attached to the base for selective adjustment in the height direction. The supports accept and securely hold threaded rods extending from the feet of an animal pre-form. The high degree of adjustability of the disclosed fixture allows the fixture to be almost universally used with a significant majority of pre-forms. The high degree of adjustability also allows the fixture to support the pre-forms in a wide range of positions for access by the taxidermist.

This disclosure also includes a method of supporting an animal pre-form of the type having at least two rods extending from at least the feet of the pre-form. The method may include providing a fixture. The fixture has a base extending along a length direction and in a height direction, and at least two supports extending upwardly relative to the base. The method includes adjusting at least one of the supports along the length direction relative to the base to match a lengthwise spacing of the rods of the pre-form, and adjusting at least one of the supports in the height direction relative to the base to match a height-wise offset of the rods of the pre-form. The pre-form is then secured to the fixture by attaching the rods to the fixture.

These and other aspects of the present invention will become apparent to those skilled in the art, after reading the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

The foregoing and still other objects and advantages of the present invention will be more apparent from the following detailed explanation of embodiments of the invention in connection with the accompanying drawings.

FIG. 1 is a front perspective view of a fixture according to embodiments of the present disclosure with a pre-form attached.

FIG. 2 is a more detailed front bottom perspective view of the fixture of FIG. 1.

FIG. 3 is a more detailed front top perspective view of the fixture of FIG. 1.

FIG. 4 is another perspective view of the fixture of FIG. 1 in a rotated orientation.

FIG. 5 is a top perspective view of the fixture of FIG. 1. with the pre-form removed.

FIG. 6 is another front perspective view of the fixture of FIG. 1 with the supports rotated and the pre-form removed.

FIG. 7 is a top rear perspective view of the fixture of FIG. 1.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, modifications and improvements of the described embodiments, will occur to those skilled in the art, and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to the apparatus, product or component aspects or embodiments and vice versa.

In many cases, taxidermists support the tanned skin of an animal using a pre-form or manikin that may be made from foam, plastic, or other materials. Pre-forms may be purchased from supply companies, such as McKenzie Taxidermy Supply, to imitate an extensive range of animal species, sizes, and poses. In other cases, pre-forms may be hand-crafted by the taxidermist himself. In many cases, the pre-forms, particularly the full body manikins, include rods extending from the feet thereof. These rods may be threaded like a bolt for engagement with a properly sized nut. Traditionally, these rods are provided for use when the completed animal is mounted to a display stand.

The shape and size of animal pre-forms make them awkward to hold and properly position as the taxidermist attempts to apply the skin. Some taxidermists have been known to craft disposable stands uniquely constructed based on the particular pre-form being used for a given project. Applicant has determined that there is a need for a more permanent and universally adjustable solution in the form of an adjustable fixture to accommodate a wide range of animal sizes, species, and poses while providing hands-free access to the pre-form from several angles.

As used herein, the term “skin” should be considered broadly as the natural portion of an animal being preserved and displayed during the taxidermy process. Therefore, the term “skin” may include, and be used interchangeably with: skin, fur, feathers, scales, hide, etc.

As used herein, the term “pre-form” may be used interchangeably with the term “manikin”. Pre-forms are formed prior to applying the skin. Pre-forms may be created by the taxidermist or pre-made and purchased from a supply company. Pre-forms may be life-size or less than life-size, such as half-size. For purposes of this disclosure, pre-forms preferably represent the full body or substantially the full body of the imitated animal. However, in some embodiments, pre-forms of less than the full body, such as hoods, heads, heads and shoulders, etc., may be used with the disclosed fixtures.

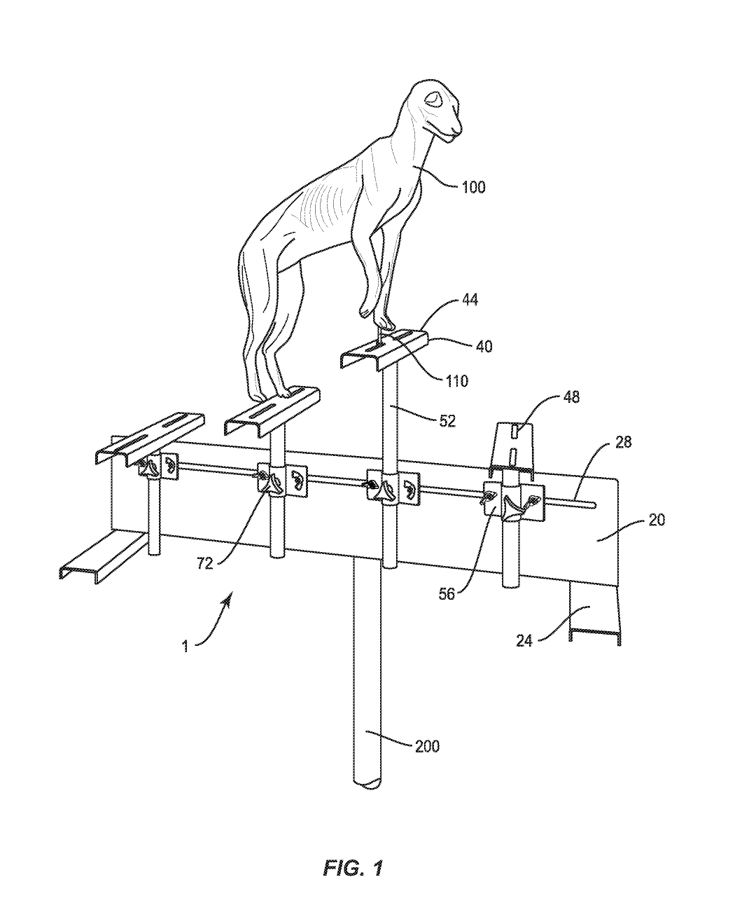

Turning to the figures, FIG. 1 shows a pre-form 100 secured to a fixture 1 according to embodiments of the present disclosure. Fixture 1 may be described by other terms such as a stand, a holder, a support, or a jig. The fixture 1 includes a base 20 and at least two supports 40.

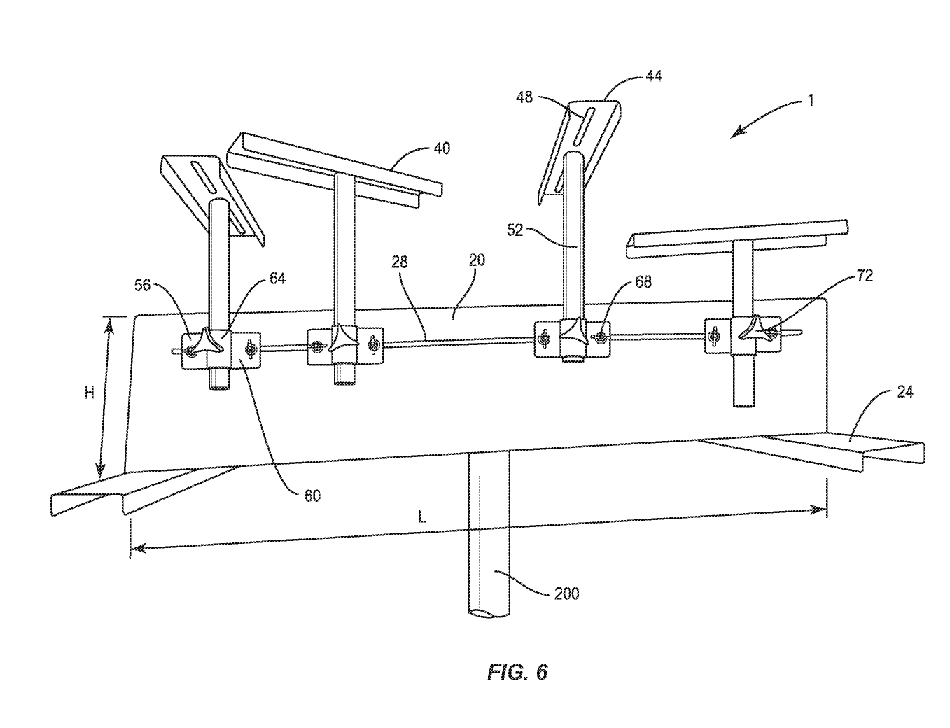

The base 20 is a plate, bar, or sheet formed of metal, wood, composite, polymer, or other suitable strong and rigid structural material. The base 20 extends along a length direction L and in a height direction H (see FIG. 6). In some embodiments, the base 20 is about forty inches long, depending on the size and number of pre-forms 100 to be held. The effective minimum length corresponds with the minimum spacing between supports 40, and may be as little as a few inches. Further, by fully separating the supports 40, and rotating the supports generally parallel with the length direction, additional effective length may be possible. These dimensions have been found to be large enough to support a vast majority of pre-form species, making the fixture 1 substantially universal, keeping in mind that the spacing of the feet of a pre-form 100 is often less than the full nose-to-tail dimension of the animal. If a pre-form 10 of smaller animals is used, the fixture 1 may be capable of supporting several pre-forms at one time.

The fixture 1 shown in FIG. 1 includes four supports 40, however the number of supports may obviously vary. The preferred embodiment includes four supports 40 to match an anticipated maximum number of feet of a relatively large animal, i.e. attachment points, on any given pre-form 100. As seen in FIG. 1, some pre-forms 100 may not make use of all of the available supports 40. Therefore, four supports 40 are not necessary as part of the fixture 1. It is expected that at least two supports 40 should be provided. In some embodiments, the number of supports 40 may vary by removably securing the supports 40 to the base 20.

The base 20 may include a pair of legs 24 attached to the bottom portion of the base 20. The legs 24 may be included for supporting the fixture 1 upon a work surface, such as a table or the floor. The legs 24 are preferably removable, foldable, or otherwise adjustable relative to the base 20 so that the legs 24 do not obstruct use of the fixture 1 when the legs 24 are unnecessary for supporting the fixture 1. In the embodiment shown, the legs 24 are removable by being bolted to the base 20.

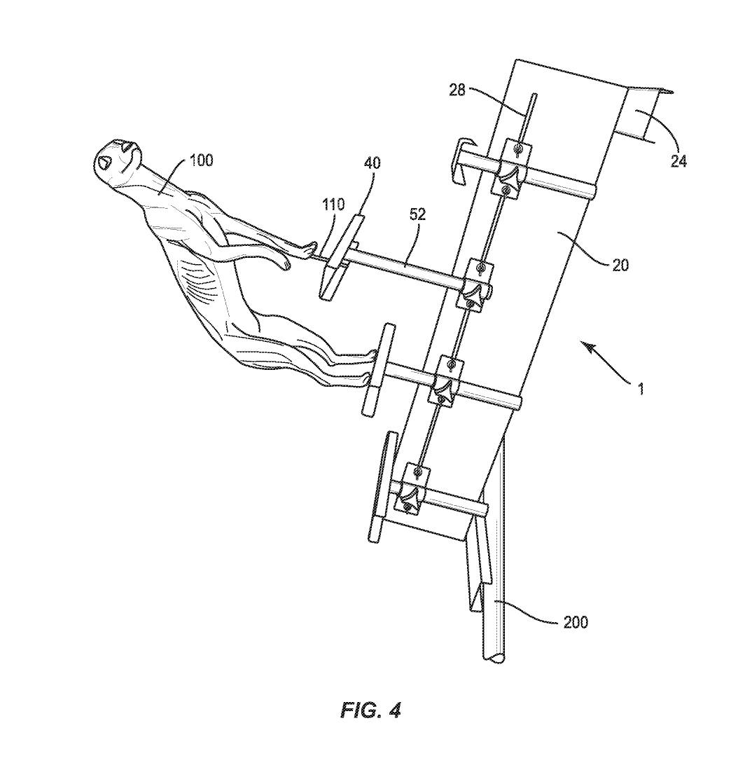

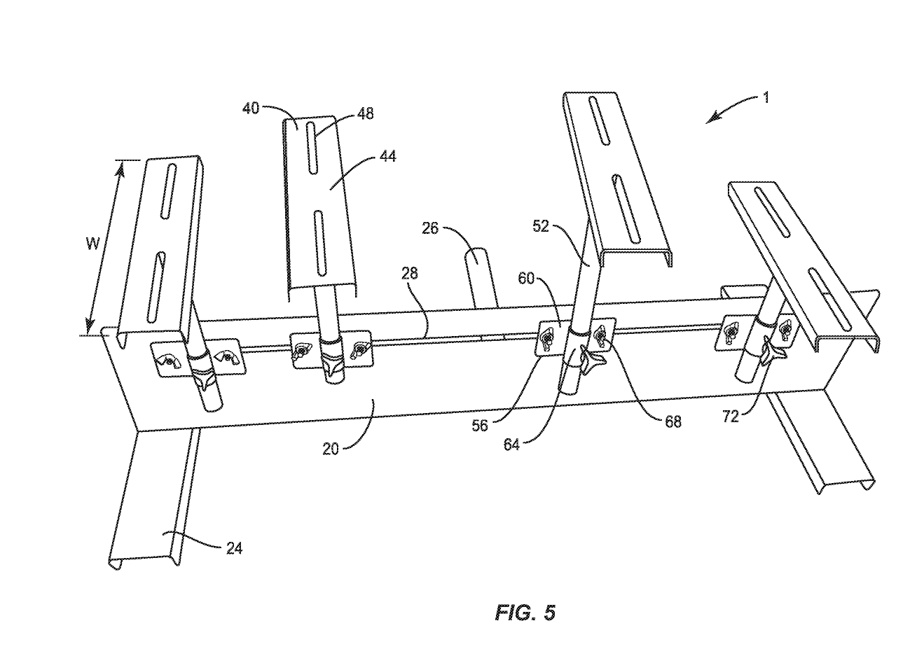

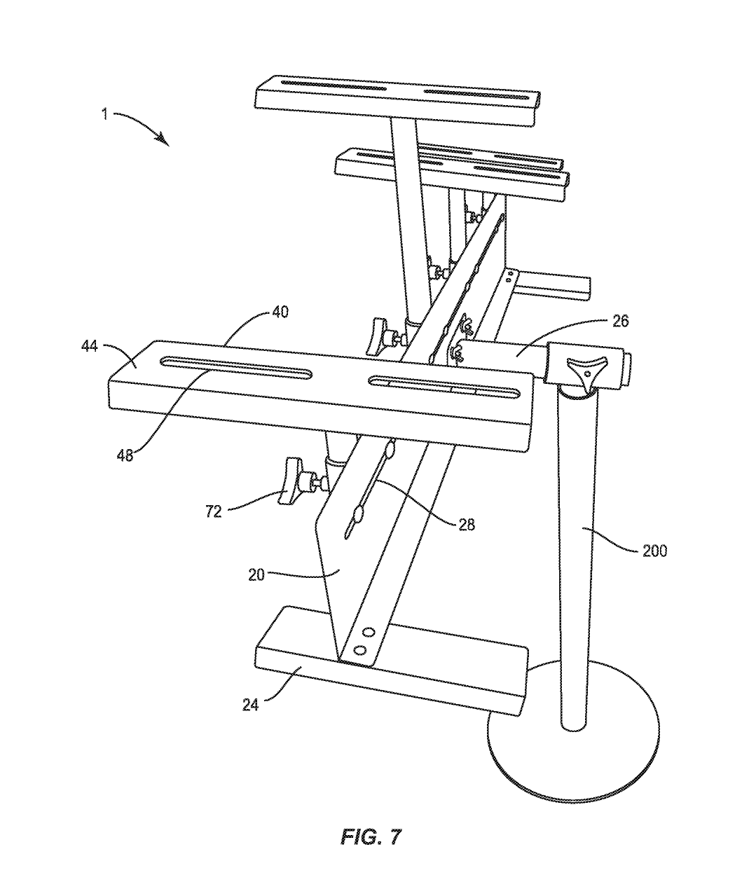

As best seen in FIGS. 5 and 7, the base 20 may also include a mounting post 26 extending from a rear side of the base 20. The mounting post 26 is configured to engage a conventional stand 200. Supporting the fixture 1 via the mounting post 26 secured in a conventional stand 200 allows for the fixture 1 to be rotated about a horizontal, longitudinal axis of the mounting post. After rotating the fixture 1, the mounting post 26 is secured in place relative to the stand 200. Providing for rotation allows for changing the angle of the fixture 1 relative to the work surface, as shown in FIG. 4. As a result, the pre-form 100 may be angled for optimal working conditions for the taxidermist. With the legs 24 removed or otherwise adjusted, the fixture 1 should be capable of rotating a full 360 degrees. As can be seen, the base 20 can be supported by the stand 200 or the legs 24 depending on where the taxidermist chooses to work at any point in time. Again, the adjustability of the fixture 1 provides for both substantially universal mounting of animal pre-forms 100, but also an ability to position those pre-forms in a variety of orientations for ease of access by the taxidermist.

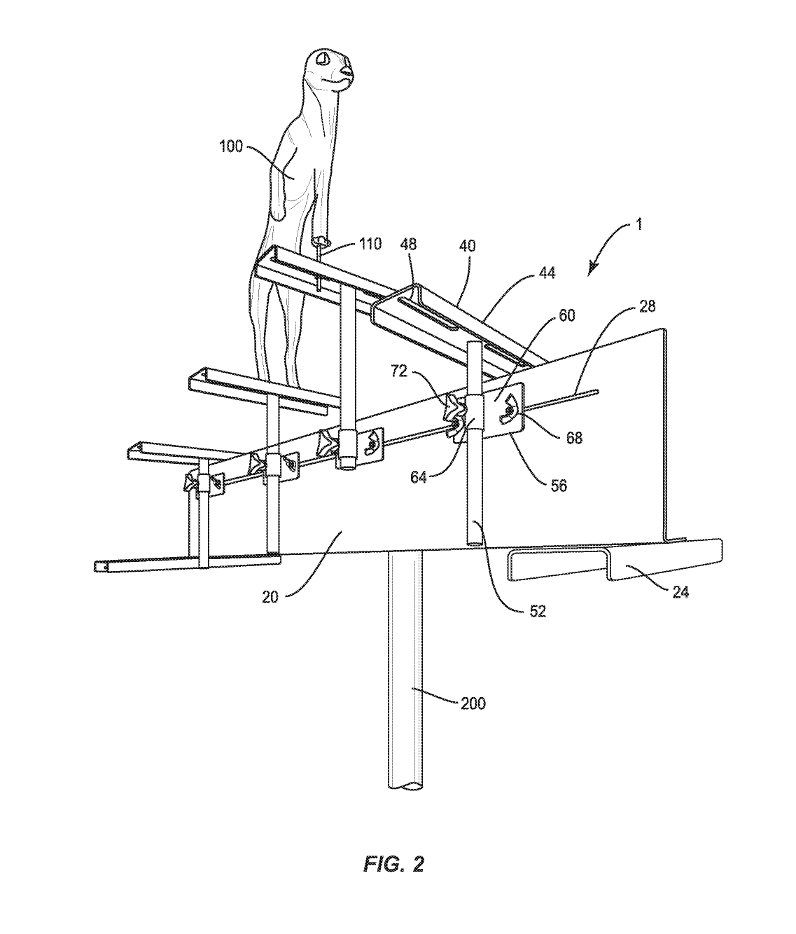

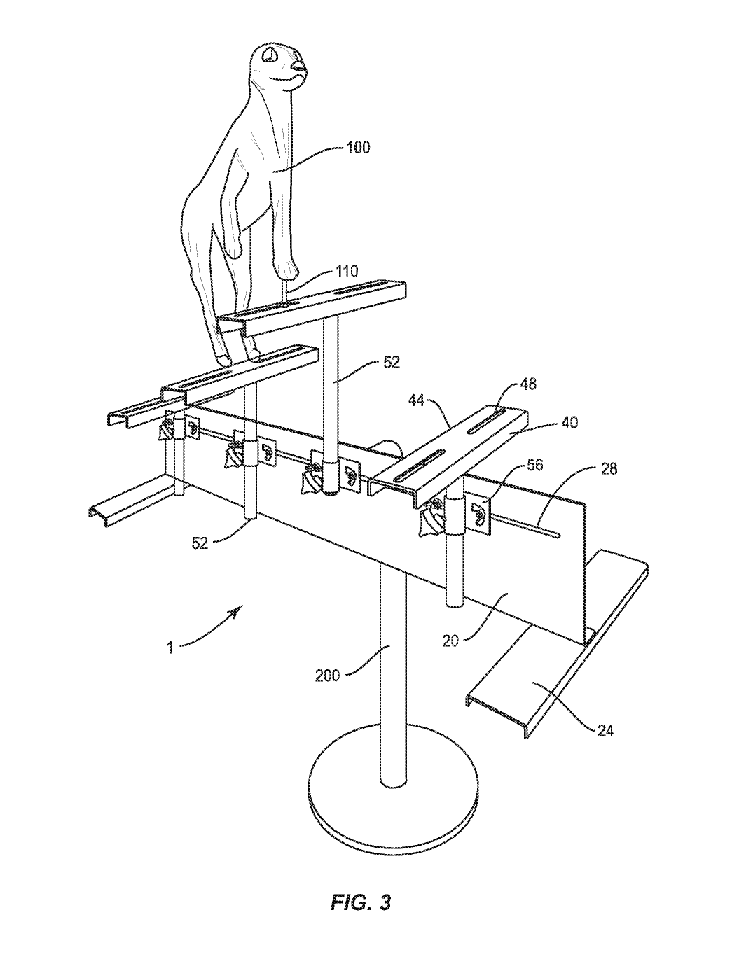

The base 20 may include a lateral adjustment slot 28 along the length direction, as best seen in FIGS. 2-4. The lateral adjustment slot 28 allows the supports 40 to slide along the length direction relative to the base 20 to adjust the lateral spacing between the supports 40. The lateral adjustment slot 28 may be a single slot extending nearly the full length of the base 20. In other embodiments, the lateral adjustment slot 28 may comprise more than one slot, such as a separate slot for each support 40. In yet other embodiments, the lateral adjustment slot 28 may not be a slot at all, but a series of closely spaced apertures for selective use in securing each support 40 at various positions along the length of the base 20.

The supports 40 may include an attachment plate 44 with one or more openings 48 or slots therein. The attachment plate 44 connects with the rods 110 of the pre-form 100. The attachment plate 44 has a width W (best seen in FIG. 5). The width W may be between about 3 and about 18 inches to accommodate a variety of widthwise spacing between the rods 110 of the pre-form 100. The opening 48 may be in the form of a slot or a series of holes, again to provide some front to rear positioning of the pre-form's rods 110. The opening 48 may extend as much of the width of the attachment plate 44 as possible. Therefore, there is adjustment of the fixture 1 to accommodate rods 110 having various spacing in three directions, i.e. up or down; side to side; and front to rear.

The supports 40 may each include a support post 52. The attachment plate 44 may be fixed to the top of the support post 52. In other embodiments, the attachment plate 44 may be joined to the top of the support post 52 by any form of swivel connector known in the art, to provide additional degrees of freedom of movement. In one embodiment, the support post 52 has a circular cross section to allow the support post 52 to rotate about its length (an axis parallel to the height direction), and allow the attachment plate 44 to swivel relative to the base 20, as seen in FIG. 6. The support post 52 may be between about 8 and about 15 inches in length to provide sufficient vertical adjustability of the attachment plates 44. In some embodiments, the support posts 52 are different lengths to allow some supports 40 to adjust vertically more than others.

As best seen in FIG. 2, the supports 40 may further comprise brackets 56 for adjustably attaching the supports 40 to the base 20. In one embodiment, each bracket 56 has a base attachment portion 60 and a post attachment sleeve 64. In the illustrated embodiments, fasteners 68, such as wing-nuts, nuts and bolts, extend through the base attachment portion 60 and the lateral adjustment slot 28. With the fasteners 68 loosened, the support 40 can be moved along the lateral adjustment slot 28. With the fasteners 68 tightened, the support 40 is held in position along the length direction. Fasteners 68 may also be disconnected to remove the support 40 from the base 20.

In the illustrated embodiment, a set screw 72 threadably passes through the post attachment sleeve 64. When the set screw 72 is in a tightened position, the support post 52 and attachment plate 44 are held at a fixed height above the base 20. When the set screw 72 is in a loosened position, the support post 52 may be adjusted in the height direction, rotated about its length, or removed from the bracket 56 completely.

It should be understood that this disclosure describes one embodiment as provided in the accompanying figures. One of ordinary skill in the art will understand that the functions and advantages provided by the fixture 1 as described herein may be provided by other mechanical joints and connectors known in the art that would provide the same or substantially similar ability for the supports 40 to be selectively adjustable along both the length direction and in the height direction relative to a base 20.

One skilled in the art will also understand that the use of the fixture 1 may be described in terms of a method of supporting a pre-form 100 used during taxidermy. First, the pre-form 100 is understood to have at least two rods 110 extending from feet, or other portions of the pre-form 100. A fixture 1 according to this disclosure is provided such that the fixture 1 comprises a base 20 extending along a length direction and in a height direction, and at least two supports 40 extending upwardly relative to the base 20. The method of supporting continues by adjusting at least one of the supports 40 along the length direction relative to the base 20 to match a lengthwise spacing of the rods 110 of the pre-form 100, and adjusting at least one the supports 40 in the height direction relative to the base 20 to match a height-wise offset of the rods 110. Once the fixture 1 has been adjusted to match the size, spacing and posture of the pre-form 100, the rods 110 are joined to the attachment plates 44 by passing the rods 110 through the opening 48 and securing the rods 110 with a wing-nut, nut or other fastener.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

I claim:

1. An adjustable fixture for taxidermists, comprising:
a base having a length defining a length direction and a height defining a height direction;
at least two supports adjustably attached to the base for selective adjustment along the length of the base;
wherein the at least two supports are also adjustably attached to the base for selective adjustment in the height direction; and
wherein the supports are configured to accept and securely hold rods extending from feet of an animal pre-form.

2. The fixture of claim 1, wherein the supports are mounted to the base for selective rotation about an axis parallel with the height direction.

3. The fixture of claim 1, further comprising legs attached to a bottom portion of the base for supporting the fixture on a work surface.

4. The fixture of claim 1, further comprising a mounting post extending from a rear side of the base, the mounting post configured to be held by a stand and allow the fixture to rotate with respect to the stand.

5. The fixture of claim 1, wherein the at least two supports each comprise:
an attachment plate having at least one opening for receiving the rod;
a support post extending below the attachment plate; and
a bracket for mounting the support post to the base.

6. The fixture of claim 5, wherein the at least one opening is a slot configured such that the fixture can receive rods having a variety of spacing along a width direction perpendicular to the height and length directions.

7. The fixture of claim 1, wherein the supports are rotatable relative to the base to be capable of accepting and securely holding rods that are spaced further apart than the length of the base.

8. A method of supporting an animal pre-form, the pre-form having at least two rods extending from feet of the pre-form, the method comprising:
providing a fixture, the fixture comprising:
a base having a length defining a length direction and a height defining a height direction; and
at least two supports extending upwardly relative to the base;
adjusting at least one of the supports along the length direction relative to the base to match a lengthwise spacing of the rods of the pre-form;
adjusting at least one of the supports in the height direction relative to the base to match a height-wise offset of the rods of the pre-form; and
securing the rods of the pre-form to the supports of the fixture.

9. The method of claim 8 where the fixture has a mounting post, and the method further comprises:
attaching the fixture to a stand via the mounting post; and
rotating the fixture relative to the stand.

10. The method of claim 8 where the fixture has four supports and the pre-form has less than four rods, and the method further comprises:
removing at least one of the supports from the base such that the number of supports equals the number of rods on the pre-form.
